(19) United States
(12) Patent Application Publication
(10) Pub. No.: US 2025/0327000 A1
(43) Pub. Date: Oct. 23, 2025

(54) MATRIX STRUCTURE FOR A LAUNDRY DETERGENT COMPOSITION, LAUNDRY DETERGENT SOLID COMPOSITION, PROCESS TO PRODUCE A SOLID LAUNDRY DETERGENT COMPOSITION, UNIT DOSAGE DETERGENT FORM, USE OF MICROFIBRILLATED CELLULOSE

(71) Applicant: Suzano S.A., Salvador (BR)

(72) Inventors: Matheus Antunes GUIMARÃES, Aracruz (BR); Richieli Teles VIEIRA, Osasco (BR); Bruna Papa SPADAFORA, Americana (BR)

(21) Appl. No.: 18/281,059

(22) PCT Filed: Mar. 11, 2022
(86) PCT No.: PCT/BR2022/050086

§ 371 Date: Sep. 8, 2023

Related U.S. Application Data
(60) Provisional application No. 63/159,860, filed on Mar. 11, 2021.

(51) Int. Cl. C11D 17/00; C11D 1/22; C11D 3/22

(52) U.S. Cl. CPC C11D 17/0047; C11D 1/22; C11D 3/222; C11D 2111/12

(57) ABSTRACT

The invention is directed to a matrix structure for a laundry detergent composition in a solid form having at least 15% of microfibrillated cellulose (MFC). Inclusion of a surfactant into the MFC matrix structure provides a laundry detergent solid composition having from 5% to 20% of microfibrillated cellulose. Also, it is provided a process to produce a solid laundry detergent composition having the steps of blending microfibrillated cellulose with at least one surfactant, a compression enhancing agent and compacting the resulting mixture to obtain a solid laundry detergent.

### FIELD OF INVENTION

The invention is directed to a matrix structure for a laundry detergent composition in solid form having at least 5% of microfibrillated cellulose (MFC). Inclusion of a surfactant into the MFC matrix structure provides a laundry detergent solid composition having from 5% to 20% of microfibrillated cellulose. Also, it is provided a process to produce a solid laundry detergent composition having the steps of blending microfibrillated cellulose with at least one surfactant, a compression enhancing agent and compacting the resulting mixture to obtain a solid laundry detergent.

### BACKGROUND

The present invention is directed to providing a matrix structure for a laundry detergent composition in a solid form, providing good handling and disintegrability.

Transportation of laundry detergents become a problem when the detergent has high levels of fillers. A filler is sometimes necessary in markets where the detergent is perceived by the amount used, and not by its power of cleansing. In this sense, some markets resist the removal of fillers, opting for the detergents that exhibit the higher volume, for the same price of a detergent free from fillers. Also, fillers perform an important task in granular detergent powders to avoid aggregation of the powder and providing free flowing when dispensed from the detergent container.

The use of fillers and the perception of the necessity of volume are circumvented when using the detergent in a compacted form. Usually, the compacted form may be an indication of a unitary dose, or even in fraction of a dose, allowing the consumer to regulate the number of tablets to use depending upon the amount of laundry, quality of the water (e.g., if hard water), severity of dirtiness, etc. Compaction may be achieved using a microfibrillated cellulose (MFC) matrix. The state of the art discloses use of cellulose in solid detergents, such as WO2017125727A1. This document uses microcrystalline cellulose as a filler but does not disclose the use of microfibrillated cellulose.

The US application published as US 2020/0255776 A1 discloses a washing or cleaning product including a solid composition wherein said composition comprises MFC as a rheology modifier, that is, MFC is used in the composition described in said document as a component to enhance the viscosity of the composition, as a thickener.

Therefore, there is still a need in the art for a solid detergent composition which provides enhanced handling and disintegrability through a composition that has better structure and resistance to compression. The use of MFC as a network structuring provider allows this need to be fulfilled.

### BRIEF DESCRIPTION OF THE INVENTION

The present invention is directed to a matrix structure for a laundry detergent composition in a solid form having at least 5% wt. of microfibrillated cellulose (MFC), used as a network structuring provider. Inclusion of a surfactant into the MFC matrix structure provides a laundry detergent solid composition having from 5% to 20% wt. of microfibrillated cellulose. The composition comprises a compression enhancing agent, preferably, 13% to 17% wt. of sodium sulfate. Also, it is provided a process to produce a solid laundry detergent composition having the steps of blending microfibrillated cellulose with at least one surfactant, a compression enhancing agent and compacting the resulting mixture to obtain a solid laundry detergent.

### DETAILED DESCRIPTION OF THE INVENTION

The present invention is directed to providing a matrix structure for a laundry detergent composition in a solid form, providing good handling and disintegrability, besides resistance to compression.

The weight percentages as described in the present invention are related to the final active content of the components (MFC, surfactant, compression enhancing agent) in the detergent composition.

In a first embodiment, the present invention provides a matrix structure for a laundry detergent composition in a solid form, comprising at least 5% wt. of microfibrillated cellulose (MFC), preferably comprising from 5% to 20% wt. of MFC, more preferably between 8% and 12% wt..

The matrix structure is formed of microfibrillated cellulose having an average diameter of 100 nm to 800 nm. It has been observed that MFC having a solids percent higher than 10% forms stable solid structures that may incorporate secondary ingredients, e.g., detergents. However reasonably stable, when pressed for manipulation such structures may crumble or deteriorate under manipulation. On the other hand, MFC provides strong networks and compacting such matrix structures provides good physical stability to the matrix and the compacted unit may be manipulated for, among other things, transportation, and insertion into a laundry machine.

In an aspect of the present invention, the MFC matrix structure may have included in it at least a surfactant, providing a solid laundry detergent composition, and a compression enhancing agent. The incorporation of a surfactant into the MFC provides a solid laundry detergent composition that generally may be compacted, retaining the provided shape to the composition. Moreover, the incorporation of a compression enhancing agent allows the composition to better resist compression.

The solid laundry detergent composition may comprise a final active content from 10% to 20% wt. of a surfactant. The surfactant may be selected from an anionic surfactant, a non-ionic surfactant, an anionic and nonionic surfactant.

Suitable anionic surfactants include those surfactants that contain a long chain hydrocarbon hydrophobic group in their molecular structure and a hydrophilic group, including salts such as carboxylate, sulfonate, sulfate or phosphate groups. Suitable anionic surfactant salts include sodium, potassium, calcium, magnesium, barium, iron, ammonium and amine salts. Other suitable secondary anionic surfactants include the alkali metal, ammonium and alkanol ammonium salts of organic sulfuric reaction products having in their molecular structure an alkyl, or alkaryl group containing from 8 to 22 carbon atoms and a sulfonic or sulfuric acid ester group. Examples of such anionic surfactants include water soluble salts of alkyl benzene sulfonates having between 8 and 22 carbon atoms in the alkyl group, alkyl ether sulfates having between 8 and 22 carbon atoms in the alkyl group. The anionic surfactant may be selected from linear alkyl benzene sulphonate; alkyl sulphates; alkyl ether sulphates; and mixtures thereof. The anionic surfactant may be selected from linear alkyl benzene sulphonate; alkyl sulphates; alkyl ether sulphates; soaps; alkyl (preferably methyl) ester sulphonates, and mixtures thereof. Nonionic surfactants may be selected from alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkyl polyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), poly hydroxyalkyl fatty acid amides, or/V-acyl N-alkyl derivatives of glucosamine (glucamides, GA, or fatty acid glucamides, FAGA), as well as products available under the trade names SPAN and TWEEN, and combinations thereof. Suitable cationic detersive surfactants include alkyl pyridinium compounds, alkyl quaternary ammonium compounds, alkyl quaternary phosphonium compounds, alkyl ternary sulphonium compounds, and mixtures thereof.

The surfactant may be blended with the MFC and then compacted. Compaction should be adequate to provide good disintegrability while retaining physical integrity for manipulation. Compacted forms are a tablet, a pellet, a granule, bar and powder.

The solid laundry detergent composition may comprise a final active content from 13% to 17% wt. of sodium sulfate as the compression enhancing agent.

Moisture is an important item for performance of the matrix structure or the laundry detergent composition in a solid form. A balance between handling and disintegrability can be achieved for a moisture content of 45% to 65% wt. in the laundry detergent composition of the present invention. Having such a moisture content and compaction providing a bulk density of 400 g/L to 700 g/L provides good dispersibility. In the present invention, the laundry detergent solid composition has a dispersibility of 100% when measured in water at 25° C. via dispersibility test.

The microfibrillated cellulose also allows the incorporation of binders, builders, disintegrants and fillers in small amounts or no incorporation at all.

If included, a builder may be used, such as homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), etheylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diylbis(phosphonic acid) (HEDP), ethylenediaminetetra-kis(methylene)tetrakis(phosphonic acid) (EDTMPA), diethylenetriaminepentakis (methylene) pentakis(phosphonic acid) (DTPMPA), N-(2-hydroxyethyl)iminodiacetic acid (EDG), aspartic acid-N-monoacetic acid (ASMA), aspartic acid-?,?-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), a-alanine-N,N-diacetic acid (a-ALDA), serine-N,N-diacetic acid (SEDA), isoserine-N,N-diacetic acid (ISDA), phenylalanine-N,N-diacetic acid (PHDA), anthranilic acid-N,N diacetic acid (ANDA), sulfanilic acid-N, N-diacetic acid (SLDA), taurine-N, N-diacetic acid (TUDA) and sulfomethyl-N, N-diacetic acid (SMDA), N-(hydroxyethyl)-ethylidenediaminetriacetate (HEDTA), diethanolglycine (DEG), Diethylenetriamine Penta (Methylene Phosphonic acid) (DTPMP), aminotris(methylenephosphonic acid) (ATMP), and combinations and salts thereof.

In one aspect, the present invention provides a process to produce a solid laundry detergent composition comprising the steps of:
a) Blending microfibrillated cellulose with at least one surfactant and a compression enhancing agent;
b) Compacting and homogenizing the resulting mixture in a single screw extruder to obtain a solid laundry detergent.

In one aspect, the microfibrillated cellulose supplied to the process is at least 5% wt. solids, preferably 10% to 25% wt. solids, more preferably 20% wt. solids.

In one aspect, the present invention provides solid laundry detergent composition produced by compressing a blend of 5% to 20% wt. of a final active content of microfibrillated cellulose, a final active content of 10% to 20% wt. of a surfactant and a final active content of 13% to 17% of sodium sulfate.

Compaction methods may include tableting, extrusion, pelleting, granulation, bar formation.

In one aspect, the present invention provides a detergent composition in a single dose forming a unit dose detergent comprising at least 5% wt. of final active content of microfibrillated cellulose, a surfactant and a compression enhancing agent.

The solid compositions of the present invention may also comprise enzymes or enzymatic blends. The enzyme provides enhanced cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, beta-glucanases, arabinosidases, hyaluronidase, chondroitinase, laccase, chlorophyllases and amylases, or mixtures thereof. A typical combination is an enzyme cocktail that may comprise e.g., a protease and lipase in conjunction with amylase. When present in the laundry detergent solid composition, the enzyme or enzyme blend may be present at levels from 0.00001 to 2%, from 0.0001 to 1%, more preferably from 0.001 to 0.5% of enzyme protein by weight of the laundry detergent solid composition. In general, the properties of the selected enzyme(s) should be compatible with the selected detergent, (i.e., pH-optimum, compatibility with other enzymatic and non-enzymatic ingredients, etc.), and the enzyme(s) should be present in effective amounts.

### Tests

Tests were performed to evaluate the laundry detergent composition in a solid form. Several compositions were tested and provided good results for handling and dispersibility, as shown at Table 1.

TABLE 1
(with base on active amount):

| Material | F03 | F04 | F06 | F09 | F10 |
|---|---|---|---|---|---|
| MFC 10% | — | — | — | — | — |
| MFC 20% | 56.30 | 46.30 | 55.80 | 50.30 | 40.30 |
| Dodecyl Benzene | 40.00 | 50.00 | 40.00 | 40.00 | 50.00 |
| Sulfonate Sodium 40% | | | | | |
| Optical Bleaching | 0.10 | 0.10 | 0.10 | 0.10 | 0.10 |
| Trans-sodium EDTA | 1.00 | 1.00 | 1.00 | 1.00 | 1.00 |
| 86% | | | | | |
| 30% Sodium | 2.00 | 2.00 | 2.00 | 2.00 | 2.00 |
| Polyacrylate | | | | | |
| Biocide Powder | 0.10 | 0.10 | 0.10 | 0.10 | 0.10 |
| Essence Oil | 0.50 | 0.50 | 0.50 | 0.50 | 0.50 |
| Enzymatic Blend | | | 0.50 | 0.50 | 0.50 |
| Sodium Percarbonate | | | | 5.00 | 5.00 |
| Tetraacetylethylenediamine | | | | 0.50 | 0.50 |

| Tests | F03 | F04 | | F09 | F10 |
|---|---|---|---|---|---|
| Immediate | good | good | good | good | good |
| Organoleptic | | | | | |
| Appearance | | | | | |
| Organoleptic | good | good | good | good | good |
| Appearance after 7 | | | | | |
| days | | | | | |
| Full Machine Wash | Approved | Approved | Approved | | |
| Test | | | | | |

Table 1.1 below shows several compositions comprising the compression enhancing agent sodium sulfate that were tested and provided good results for handling, dispersibility and stability. All values are in weight percentage.

TABLE 1.1

| Material | F15 | F21 | F22 | F23 | F24 | F25 | F26 | F27 | F28 | F29 | F30 |
|---|---|---|---|---|---|---|---|---|---|---|---|
| MFC 20% | 40.80 | 42.80 | 38.80 | 43.80 | 45.80 | 47.80 | 45.80 | 41.80 | 47.80 | 43.80 | 49.80 |
| Dodecly Benzene | 40.00 | 40.00 | 40.00 | 37.00 | 35.00 | 33.00 | 37.00 | 37.00 | 35.00 | 35.00 | 33.00 |
| Sulfonate Sodium 40% | | | | | | | | | | | |
| Sodium Sulfate | 15.00 | 13.00 | 17.00 | 15.00 | 15.00 | 15.00 | 13.00 | 17.00 | 13.00 | 17.00 | 13.00 |
| Liquid polyacrylate | 2.00 | 2.00 | 2.00 | 2.00 | 2.00 | 2.00 | 2.00 | 2.00 | 2.00 | 2.00 | 2.00 |
| Trans-Sodium EDTA 86% | 1.00 | 1.00 | 1.00 | 1.00 | 1.00 | 1.00 | 1.00 | 1.00 | 1.00 | 1.00 | 1.00 |
| Optical Bleaching | 0.10 | 0.10 | 0.10 | 0.10 | 0.10 | 0.10 | 0.10 | 0.10 | 0.10 | 0.10 | 0.10 |
| Biocide Powder | 0.10 | 0.10 | 0.10 | 0.10 | 0.10 | 0.10 | 0.10 | 0.10 | 0.10 | 0.10 | 0.10 |
| Essence Oil | 0.50 | 0.50 | 0.50 | 0.50 | 0.50 | 0.50 | 0.50 | 0.50 | 0.50 | 0.50 | 0.50 |
| Enzymatic Blend | 0.50 | 0.50 | 0.50 | 0.50 | 0.50 | 0.50 | 0.50 | 0.50 | 0.50 | 0.50 | 0.50 |
| Results | | stable | stable | stable | stable | stable | stable | stable | stable | stable | stable |

The tests show that microfibrillated cellulose ranging from a final active content of 15% to 30% provide good Organoleptic Appearance, immediate and after 7 days, with a good performance in the Full Machine Wash Test, achieving complete disintegration of the laundry detergent composition in a solid form.

Microfibrillated cellulose introduced with a solids content of 10% may cause the laundry detergent composition in solid form to become too brittle, which may cause poor handling. Tests were performed that microfibrillated cellulose at 10% were already too low for the use in a laundry detergent composition in solid form, according to Table 2.

TABLE 2

| | F01 | F02 |
|---|---|---|
| Material | | |
| MFC 10% | 67.60 | 35.50 |
| MFC 20% | — | — |
| Dodecyl Benzene Sulfonate Sodium 40% | 30.00 | 60.00 |
| Optical Bleaching | 0.10 | 0.20 |
| Trans-sodium EDTA 86% | 1.00 | 2.00 |
| 30% Sodium Polyacrylate | 1.00 | 2.00 |
| Biocide Powder | 0.10 | 0.10 |
| Essence Oil | 0.20 | 0.20 |
| Enzymatic Blend | — | — |
| Sodium Percarbonate | — | — |
| Tetraacetylethylenediamine | — | — |
| Tests | | |
| Immediate Organoleptic Appearance | Brittle | good |
| Organoleptic Appearance after 7 days | Brittle | good |
| Full Machine Wash Test | ND | ND |

Table 3 depicts a high amount of surfactant to result in a laundry detergent composition in a solid form that is too hard for complete dispersion.

TABLE 3

| | F05 | F08 |
|---|---|---|
| Material | | |
| MFC 10% | — | — |
| MFC 20% | 36.30 | 35.70 |
| Dodecyl Benzene Sulfonate Sodium | 60.00 | 60.00 |
| 40% | | |
| Optical Bleaching | 0.10 | 0.20 |
| Trans-sodium EDTA 86% | 1.00 | 1.00 |
| 30% Sodium Polyacrylate | 2.00 | 2.00 |
| Biocide Powder | 0.10 | 0.10 |
| Essence Oil | 0.50 | 0.50 |
| Enzymatic Blend | — | 0.50 |
| Sodium Percarbonate | — | — |
| Tetraacetylethylenediamine | — | — |
| Tests | | |
| Immediate Organoleptic Appearance | Hard | Hard |
| Organoleptic Appearance after 7 | Hard | Hard |
| days | | |
| Full Machine Wash Test | ND | ND |

As it can be seen in F05 and F08 compositions, using more than a mass of surfactant more 1.5 than each of microfibrillated cellulose may cause the laundry detergent composition in a solid form to become too hard for complete dispersion, after compaction.

Also, enzymatic blends are shown to provide good properties, as shown at Table 4.

TABLE 4

| | F07 |
|---|---|
| Material | |
| MFC 10% | — |
| MFC 20% | 45.80 |
| Dodecyl Benzene Sulfonate Sodium | 50.00 |
| 40% | |
| Optical Bleaching | 0.10 |
| Trans-sodium EDTA 86% | 1.00 |
| 30% Sodium Polyacrylate | 2.00 |
| Biocide Powder | 0.10 |
| Essence Oil | 0.50 |
| Enzymatic Blend | 0.50 |
| Sodium Percarbonate | — |
| Tetraacetylethylenediamine | — |
| Tests | |
| Immediate Organoleptic Appearance | sticky |
| Organoleptic Appearance after 7 days | good |
| Full Machine Wash Test | Approved |

Further, composition F09 was compared to market-leading laundry detergents in powder and liquid forms through a screening test of washing and removing stains, particularly using standard tea; coffee; sauce; chocolate; meat and soot stains. In each fabric the standard stain was applied with silk screen until saturation was reached while having a controlled and uniform spreading. The fabrics were left with the stains at rest to dry for at least 1 day in a covered and ventilated place for fixation. Each fabric was washed in cold water for 30 minutes together with 2 kg of white fabrics without stains, using 50 g of F09 composition and using 50 g of the comparative compositions from market laundry detergents in powder and liquid forms.

Applying the present invention in household product also is disclosed the use of microfibrillated cellulose for producing a tablet detergent composition.

1. A matrix structure for a laundry detergent composition in a solid form, comprising at least 5% wt. of microfibrillated cellulose.

2. A laundry detergent solid composition comprising the matrix structure of claim 1 and from 5% to 20% wt. of final active content of microfibrillated cellulose, more preferably between 8% and 12% wt..

3. The laundry detergent solid composition of claim 2, wherein the moisture content is 65% wt. or less.

4. The laundry detergent solid composition of claim 1, wherein it further comprises a final active content of 10% to 20% wt. of a surfactant and a final active content of 13% to 17% of sodium sulfate.

5. The laundry detergent composition of claim 2, wherein the solid composition has a dispersibility of 100%.

6. The laundry detergent composition of claim 2 comprising a surfactant selected from an anionic surfactant, a non-ionic surfactant, an anionic and nonionic surfactant.

7. The laundry detergent composition of claim 2, wherein the solid composition is free from binders.

8. The laundry detergent composition of claim 2, wherein the solid composition is free from a disintegrant.

9. The laundry detergent composition of claim 2, wherein the solid composition is free from a filler.

10. A process to produce a solid laundry detergent composition from claim 2, wherein the process comprises the steps of:
a) blending microfibrillated cellulose with at least one surfactant and a compression enhancing agent;
b) compacting the resulting mixture to obtain a solid laundry detergent.

11. The process of claim 9, wherein the step b) of compacting the resulting mixture is performed in a single screw extruder to obtain a solid laundry detergent.

12. The process according to claim 9, wherein the microfibrillated cellulose is at least 5% wt. solids.

13. The process according to claim 9, wherein the compacting is selected from tableting, pelletization, formation of granule, bar forming and powder granulation.

14. A unit dosage detergent form comprising at least 5% of final active content of microfibrillated cellulose, a surfactant and compression enhancing agent.

15. The unit dosage detergent form of claim 14, wherein it further comprises a final active content of 10% to 20% wt. of a surfactant and a final active content of 13% to 17% of sodium sulfate.

16. (canceled)

17. A method for preparing the unit dosage detergent form of claim 14, comprising the step of using microfibrillated cellulose.

18. The method of claim 17, wherein the unit dosage detergent form comprises from 10 to 20 weight percent of a surfactant, and from 13 to 17 weight percent of sodium sulfate.

19. A method of cleaning laundry comprising the steps of combining laundry, water and a laundry detergent composition comprising at least 5% by weight of microfibrillated cellulose, a surfactant, and a compression enhancing agent in a laundry washing machine; and washing the laundry.

20. The method of claim 19, wherein the laundry detergent composition is in the form a unit dosage detergent.

21. The method of claim 20, wherein the unit dosage detergent comprises from 10 to 20 weight percent of a surfactant, and from 13 to 17 weight percent of sodium sulfate.
